(19) United States
(12) Patent Application Publication
(10) Pub. No.: US 2011/0019111 A1
(43) Pub. Date: Jan. 27, 2011

(54) DISPLAY MEDIUM AND RECORDING APPARATUS

(75) Inventors: Takashi Morikawa, Ebina-shi (JP); Haruo Harada, Ebina-shi (JP); Taijyu Gan, Ebina-shi (JP); Yasunori Okano, Minato-ku (JP); Atsushi Hirano, Ebina-shi (JP); Chisato Urano, Ebina-shi (JP); Chikara Manabe, Ebina-shi (JP); Takeo Kakinuma, Minato-ku (JP); Hiroshi Arisawa, Ebina-shi (JP)

Correspondence Address: SUGHRUE MION, PLLC, 2100 PENNSYLVANIA AVENUE, N.W., SUITE 800, WASHINGTON, DC, 20037, US

(73) Assignee: Fuji Xerox Co., Ltd., Tokyo (JP)

(21) Appl. No.: 12/728,614

(22) Filed: Mar. 22, 2010

(30) Foreign Application Priority Data
Jul. 21, 2009 (JP) 2009-170406

(51) Int. Cl. G02F 1/135; G02F 1/133; G02F 1/13

(52) U.S. Cl. 349/2; 349/33; 349/25

(57) ABSTRACT

A display medium comprises: a pair of electrodes to which a voltage is applied; a cholesteric liquid crystal layer provided between the pair of electrodes, wherein an alignment state of the cholesteric liquid crystal layer changes depending on a strength of an electric field generated upon application of a voltage to the pair of electrodes; and an intervening layer provided in an area between a part of the cholesteric liquid crystal layer and one of the pair of electrodes such that a strength of an electric field generated in the part of the cholesteric liquid crystal layer upon application of a voltage to the pair of electrodes is different from a strength of an electric field generated in another part of the cholesteric liquid crystal layer.

### CROSS-REFERENCE TO RELATED APPLICATIONS

This application is based on and claims priority under 35 U.S.C. 119 from Japanese Patent Application No. 2009-170406, which was filed on Jul. 21, 2009.

### BACKGROUND

1. Technical Field

The present invention relates to a display medium and a recording apparatus.

2. Related Art

A technology has been proposed in which a plurality of unevenness patterns at different densities are provided on an electrode surface of a ferroelectric liquid crystal display device to control state-switching threshold values and achieve an area gradation.

### SUMMARY

In one aspect of the present invention, there is provided a display medium comprising: a pair of electrodes to which a voltage is applied; a cholesteric liquid crystal layer provided between the pair of electrodes, wherein an alignment state of the cholesteric liquid crystal layer changes depending on a strength of an electric field generated upon application of a voltage to the pair of electrodes; and an intervening layer provided in an area between a part of the cholesteric liquid crystal layer and one of the pair of electrodes such that a strength of an electric field generated in the part of the cholesteric liquid crystal layer upon application of a voltage to the pair of electrodes is different from a strength of an electric field generated in another part of the cholesteric liquid crystal layer.

### BRIEF DESCRIPTION OF THE DRAWINGS

Exemplary embodiments of the present invention will be described in detail based on the following figures, wherein:

FIG. 1 is a block diagram showing a configuration of a recording apparatus relating to an exemplary embodiment of the present invention;

FIG. 2 is a cross-sectional view that shows a structure of an electronic paper relating to an exemplary embodiment of the present invention;

FIG. 3 shows an arrangement of an intervening layer relating to an exemplary embodiment of the present invention;

FIGS. 4A and 4B show characteristics of reflectance of a liquid crystal layer relating to an exemplary embodiment of the present invention;

FIG. 5 shows characteristics of resistance of a photosensitive layer relating to an exemplary embodiment of the present invention;

FIG. 6 is a cross-sectional view showing a configuration of an electronic paper relating to Modified Embodiment 2;

FIG. 7 shows an arrangement of intervening layers relating to Modified Embodiment 2;

FIGS. 8A and 8B show characteristics of reflectance of a liquid crystal layer relating to Modified Embodiment 2;

FIG. 9 is a cross-sectional view that shows a structure of an electronic paper relating to Modified Embodiment 3;

FIG. 10 is a cross-sectional view that shows a structure of an electronic paper relating to Modified Embodiment 4; and

FIGS. 11A and 11B show characteristics of reflectance of a liquid crystal layer relating to Modified Embodiment 5.

### DETAILED DESCRIPTION

Now, explanation will be made of an exemplary embodiment(s) of the present invention.

### Exemplary Embodiment

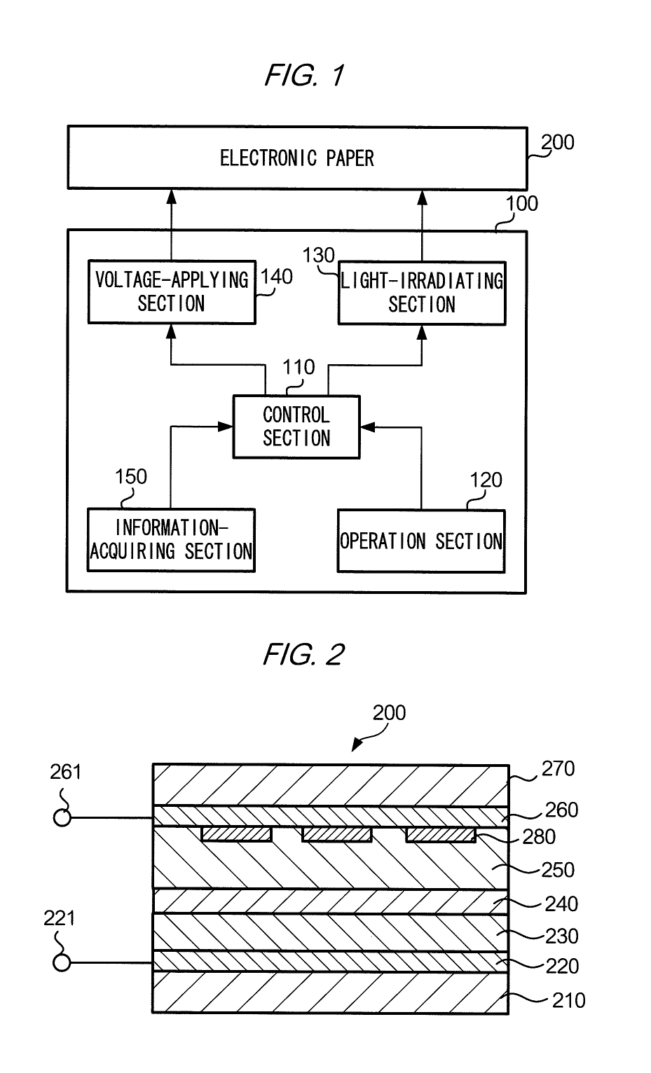

FIG. 1 is a block diagram showing a configuration of a recording apparatus 100 relating to an exemplary embodiment of the present invention. Recording apparatus 100 is an apparatus for recording images corresponding to image information on electronic paper 200 set on recording apparatus 100. Recording apparatus 100 has control section 110, operation section 120, light-irradiating section 130, voltage-applying section 140, and information-acquiring section 150.

Control section 110 includes a processing unit such as a CPU (Central Processing Unit) and a memory such as a RAM or hard disk, and controls operations of various sections of recording apparatus 100. Operation section 120 may include a touch panel, keyboard or the like via which a user can input instructions such as selection, confirmation, cancellation, etc., to recording apparatus 100. Thus, operation section 120 outputs information indicating contents of user operations to control section 110.

Light-irradiating section 130 includes a light source for irradiating light during recording of an image on electronic paper 200. The light source can be a planar light source utilizing a liquid crystal display or the like, and irradiates light toward electronic paper 200. By this light source, the light irradiated toward the electronic paper 200 is emitted from regions of the liquid crystal display, where each region consists of pixels of the liquid crystal display, and the regions that emit light are defined under the control of control section 110. As will be explained later, electronic paper 200 records an image in response to the light irradiation, and thus the size of a single pixel in electronic paper 200 corresponds to the size of a single pixel in the liquid crystal display (or a minimum light irradiation size controllable by the liquid crystal display).

It should be noted that the light source may comprise a semiconductor laser device, light emitted from which is reflected on a reflecting member such as a rotating polygon mirror, so that the reflected light forms a spotlight-like light that impinges upon desired pixels of electronic paper 200, where the pixels serve as units in displaying an image. Also, the light source may be constituted by an LED array including a plurality of LEDs (Light Emitting Diodes) arranged in a linear pattern and lenses for focusing the light emitted from each LED to an area corresponding to a resolution desired for recording an image. In these cases, the irradiated light is controlled by control section 110 such that the irradiated light scans electronic paper 200.

Voltage-applying section 140 includes electrodes through which a recording voltage is applied to electronic paper 200 under the control of control section 110. When electronic paper 200 is set on recording apparatus 100, upon generation of recording voltage by voltage-applying section 140, the recording voltage is applied across transparent electrodes 220 and 260, which will be described later. It should be also noted that the recording voltage generated by voltage-applying section 140 is controlled by control section 110 such that it changes in a predetermined manner, and this change is controlled so as to synchronize with the irradiation of recording light from light-irradiating section 130. Explanation on how the recording voltage changes will be provided later.

Information-acquiring section 150 acquires a variety of items of information such as a control program, image information that indicates an image, etc. from an external device or memory not shown in the drawings. In an example, information-acquiring section 150 utilizes a communication unit, which may be wireless or wired, to acquire information from the external device(s). The acquisition of information from the external device(s) is not necessarily limited to being performed using the communication unit but may also be achieved using a semiconductor memory device such as a USB (Universal Serial Bus) memory or any of a variety of types of memory cards, or using an optical disk such as a recordable CD or DVD, and information-acquiring section 150 may include an interface for such storage media. The configuration of recording apparatus 100 has been explained above.

FIG. 2 shows a structure of electronic paper 200 that serves as a display medium of an optical recording type relating to Exemplary Embodiment of the present invention. Electronic paper 200 is a display medium of an optical recording type that displays an image recorded in response to a recording light irradiated thereon while a predetermined recording voltage is applied, and includes film substrates 210, 270, transparent electrodes 220, 260, a photosensitive layer 230, a colored layer 240, a liquid crystal layer 250, and an intervening layer 280, so that the recorded image is presented on the side of film substrate 270.

Film substrates 210, 270 are provided for protecting a surface of electronic paper 200 and supporting a shape of the same. For example, they may be made of PET (Polyethylene Terephthalate). Film substrate 210 is provided on a side of electronic paper 200 on which light is irradiated by recording apparatus 100 while film substrate 270 is disposed on a side of electronic paper 200 on which an image is recorded to be viewed by a user.

Transparent electrodes 220, 260 are layers having ITO (Indium Tin Oxide), for example. Transparent electrodes 220, 260 are connected to electrodes 221, 261, respectively. Each such electrode 221, 261 is connected to a corresponding electrode of voltage-applying section 140 in a state where electronic paper 200 is set on recording apparatus 100. In this state, when a voltage is provided from voltage-applying section 140 via electrodes 221, 261, an electric potential difference is created between the pair of transparent electrodes 220, 260.

Photosensitive layer 230 contains an electrically conductive member having an electric conductivity that changes in response to generation of photo-electric charge caused by irradiation of recording light, and an organic photoconductor (OPC) may be used therefor, for example. In response to absorption of recording light, the resistance values of portions of photosensitive layer 230 that have absorbed the light decrease. When a voltage is applied between transparent electrodes 220 and 260 by voltage-applying section 140, the voltage is divided between the layers sandwiched between transparent electrodes 220, 260. Thus, the decrease in resistance value of photosensitive layer 230 causes an increase in the ratio of divisional voltage applied to the other layers and a decrease in the ratio of divisional voltage applied to photosensitive layer 230.

Colored layer 240 is a layer observed by a user when liquid crystal layer 250 is in a state that allows light to pass therethrough. In an example, colored layer 240 appears black by absorbing light that has passed through liquid crystal layer 250. If photosensitive layer 230 is adapted to absorb incident light, colored layer 240 may be omitted. In such a case, it is desired to shield the ambient light during an image recording period, as is described later.

Liquid crystal layer 250 includes elements that can change a light-reflecting property in response to an applied voltage. For instance, liquid crystal layer 250 may include cholesteric liquid crystal (hereinafter referred to as liquid crystal) encapsulated in capsules such as micro capsules dispersed in a binder resin. The liquid crystal comprises helically aligned rod-like molecules, and can be in one of three alignment states, i.e., a planar alignment state, a focal-conic alignment state, and a homeotropic alignment state. Of these three alignment states, the planar alignment state and the focal-conic alignment state can exist bi-stably without electric field. The homeotropic alignment state is a state that appears when liquid crystal layer 250 is applied with such a voltage that generates an electric field having a sufficiently high strength to relax the helical alignment, and when application of such voltage is terminated, liquid crystal layer 250 undergoes transition into the planar alignment state. In the planar alignment state, liquid crystal layer 250 reflects light having wavelengths corresponding to helical pitches of the liquid crystal by interference reflection. The color of the light reflected by liquid crystal layer 250 in the planar alignment state may be referred to as a planar-state reflection color which, for example, may be white (hereinafter referred to as “bright”). On the other hand, when in the focal-conic alignment state, liquid crystal layer 250 allows light to pass therethrough so that the electronic paper exhibits the color of colored layer 240 (for example, black, which is referred to as “dark” hereinafter).

Intervening layer 280 is a layer formed between transparent electrode 260 and liquid crystal layer 250, and has a dielectric constant lower than that of liquid crystal layer 250. Intervening layer 280 can be formed on transparent electrode 260 that has been disposed on film substrate 270, in the following way, for example.

In one way, after the formation of transparent electrode 260 on film substrate 270, a solution of negative photoresist SU8 is spin-coated onto transparent electrode 260, and dried and baked under predetermined conditions. Thereafter, light is irradiated onto the photoresist coating in accordance with the later-described areas of intervening layer 280. Then, post-baking and developing are performed to form intervening layer 280. In another way, after the formation of transparent electrode 260 on film substrate 270, a solution of epoxy resin is applied onto transparent electrode 260 by means of ink jet printing to form projections corresponding to the areas of intervening layer 280, and then the applied epoxy resin solution is dried and cured to form intervening layer 280.

Liquid crystal layer 250 is formed on intervening layer 280 formed as described above. In this example, the surface of liquid crystal layer 250 is flattened, and hence, a part of liquid crystal layer 250 that overlaps intervening layer 280, as viewed in the direction of stacking of the layers, has a different thickness from the other part of liquid crystal layer 250. Then, this assembly is combined with film substrate 210 having colored layer 240, photosensitive layer 230, and transparent electrode 220 formed thereon, to thereby form electronic paper 200.

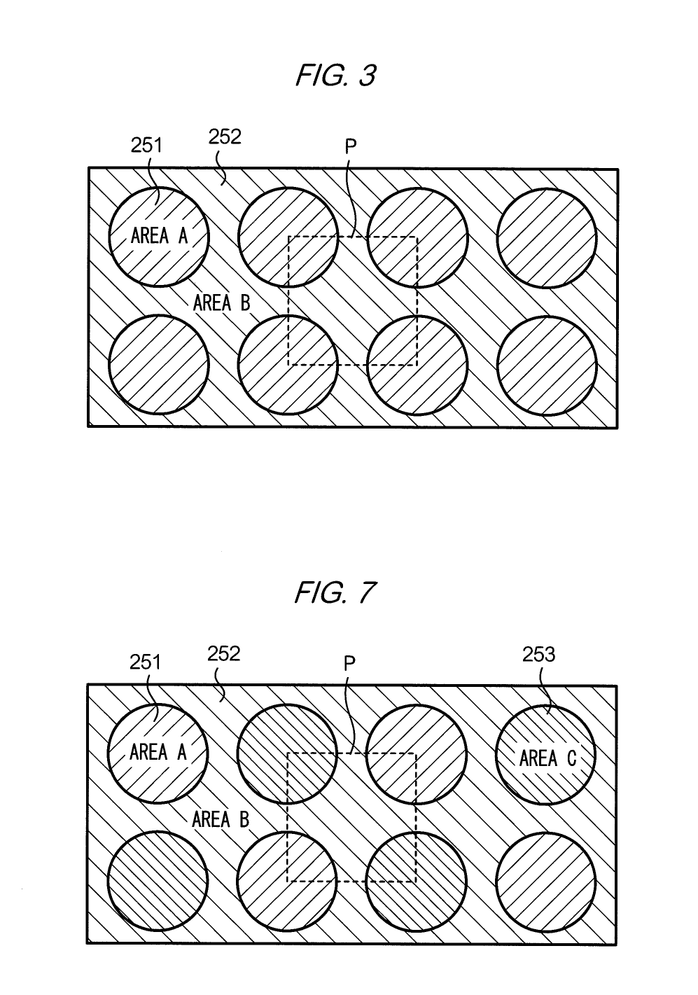

FIG. 3 shows an arrangement of intervening layer 280 viewed from the side of a display surface of electronic paper 200. Area 251 (or area “A”) is an area in which intervening layer 280 exists, while area 252 (or area “B”) is an area where intervening layer 280 does not exist. In other words, in area 251, liquid crystal layer 250 is sandwiched between intervening layer 280 and colored layer 240, and in area 252, liquid crystal layer 250 is sandwiched between transparent electrode 260 and colored layer 240. In this example, area 251 includes a plurality of circular areas, and an occupation ratio of area 251 and area 252 is determined depending on the transmittance of intervening layer 280.

In a concrete example, as described later, the alignment state of liquid crystal layer 250 is controlled so that the colors exhibited by the part of liquid crystal 250 corresponding to area 251 and the part of liquid crystal 250 corresponding to area 252 are one of three combinations, i.e., “bright, bright,” “dark, bright,” or “dark, dark,” and the occupation ratio is determined such that a normalized reflectance when liquid crystal layer 250 is controlled to exhibit the color combination of “dark, bright” is equal to ½, where the normalized reflectance is calculated such that the normalized reflectance when liquid crystal layer 250 is controlled to exhibit the color combination of “bright, bright” is equal to 1 (one). Therefore, if the transmittance of intervening layer 280 is 100%, the occupation ratio of area 251 and area 252 is 1:1, and if the transmittance of intervening layer 280 is 80%, the occupation ratio of area 251 and area 252 is about 1:0.8. It should be noted that the normalized reflectance in the state of “dark, bright” may not necessarily be ½ but may be an arbitrary value in a range greater than zero and smaller than 1.

The occupation ratio is achieved not only in the whole display area but also in each pixel (corresponding to an area P surrounded by broken lines in FIG. 3) of electronic paper 200. It is to be noted that so long as the above condition (i.e., that the occupation ratio of area 251 and area 252 in each pixel is determined in accordance with the desired normalized reflectance in the state of “dark, bright”) is satisfied, each of the plurality of discrete areas included in area 251 may not necessarily be circular and may be of any other shape such as square or elliptic. Moreover, area 251 may include a plurality of straight strip-shaped areas or may have a lattice pattern. In the case where area 251 has a lattice pattern, area 252 is divided into a plurality of areas. Also, in FIG. 3, area 251 and area 252 may be switched with one another.

As described above, the dielectric constant of intervening layer 280 is lower than that of liquid crystal layer 250, and therefore, when a potential difference is created between transparent electrodes 220, 260, the electric field generated in liquid crystal layer 250 in area 251 is weaker than the electric field generated in liquid crystal layer 250 in area 252.

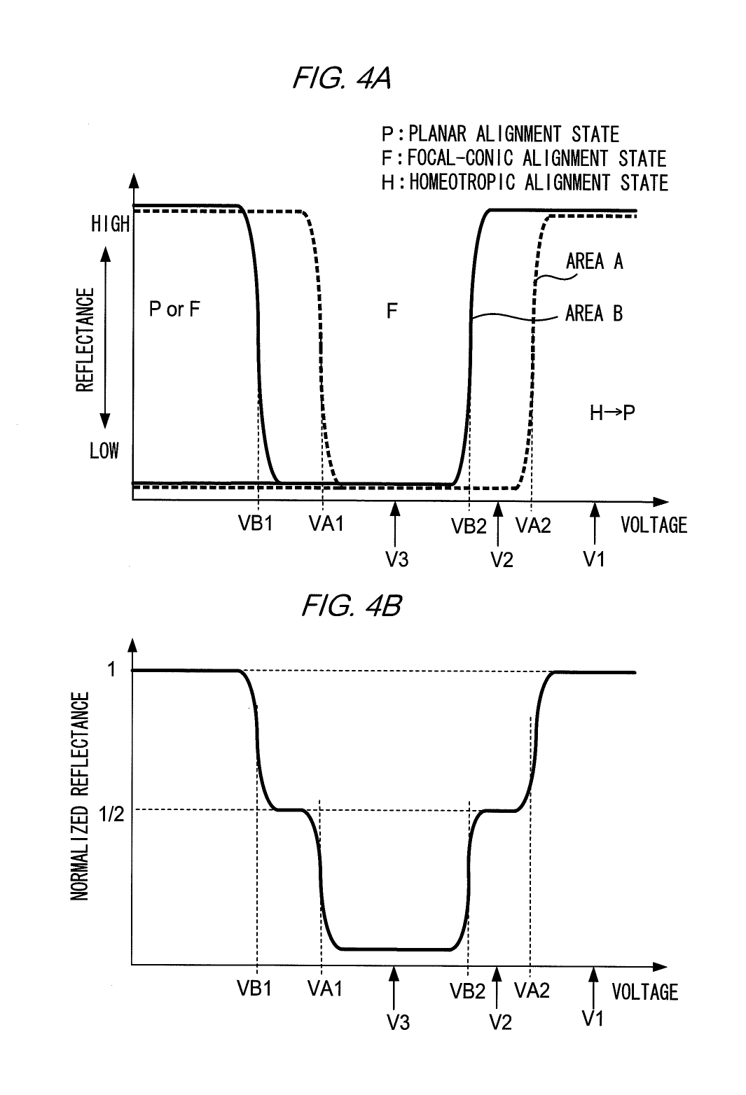

FIGS. 4A and 4B show exemplary characteristics of reflectance of liquid crystal layer 250. The vertical axis represents a reflectance of liquid crystal layer 250 while the horizontal axis represents a divisional voltage applied to liquid crystal layer 250 in area 252 (a divisional voltage applied to a stack of intervening layer 280 and liquid crystal layer 250 in area 251) when a voltage is applied between electrodes 221, 261. In the following description, the voltage applied to liquid crystal layer 250 means a divisional voltage applied to liquid crystal layer 250 in area 252 (a divisional voltage applied to a stack of intervening layer 280 and liquid crystal layer 250 in area 251).

Referring to FIG. 4A, explanation will be made of a change of reflectance of liquid crystal layer 250 in respective areas with reference to the voltage applied to liquid crystal layer 250. When the voltage applied to liquid crystal layer 250 increases to be equal to or greater than a voltage VB1, the liquid crystal layer 250 in area 252 undergoes transition into the focal-conic alignment state from an alignment state before the application of the voltage. When the voltage further increases to be equal to or greater than a voltage VA1, liquid crystal layer 250 in area 251 also undergoes transition into the focal-conic alignment state from an alignment state before application of the voltage. When the voltage increases still further to be equal to or greater than a voltage VB2, liquid crystal layer 250 in area 252 undergoes transition into the homeotropic alignment state. When the voltage increases yet further to be equal to or greater than a voltage VA2, liquid crystal layer 250 in area 251 also undergoes transition into the homeotropic alignment state.

The reason different voltages are required for alignment state transitions in different areas of the same liquid crystal layer 250 is that, as described above, when a potential difference is applied between transparent electrodes 220, 260, the electric field generated in liquid crystal layer 250 in area 251 is weaker than the electric field generated in liquid crystal layer 250 in area 252, and hence liquid crystal layer 250 in area 251 requires a higher voltage for alignment state transition than liquid crystal layer 250 in area 252.

In a state where a voltage V1, which is equal to or greater than voltage VA2, is applied to liquid crystal layer 250, liquid crystal layer 250 is in the homeotropic alignment state in each of areas 251 and 252, and termination of application of the voltage causes liquid crystal layer 250 in each of areas 251, 252 to undergo transition into the planar alignment state where the reflectance is high, so that each area exhibits the planar-state reflection color (bright).

In a state where a voltage V2, which is equal to or greater than voltage VB2 and smaller than voltage VA2, is applied to liquid crystal layer 250, liquid crystal layer 250 is in the focal-conic alignment state in area 251 and in the homeotropic alignment state in area 252. Consequently, termination of application of the voltage causes liquid crystal layer 250 in area 251 to exhibit black color (dark) owing to a low reflectance while causing liquid crystal layer 250 in area 252 to exhibit the planar-state reflection color (bright). Thus, a portion of liquid crystal layer 250 corresponding to a single pixel, which contains areas 251 and 252 as described above, exhibits an intermediate reflectance.

In a state where a voltage V3, which is equal to or greater than voltage VA1 and smaller than voltage VB1, is applied to liquid crystal layer 250, liquid crystal layer 250 is in the focal-conic alignment state in each of areas 251 and 252. Consequently, liquid crystal layer exhibits black color (dark) both in each of 251 and 252. Thus, a portion of liquid crystal layer 250 corresponding to a single pixel exhibits a reflectance having characteristics with respect to the applied voltage as shown in FIG. 4B.

As described above, intervening layer 280 of Exemplary Embodiment functions to control the thickness of liquid crystal display layer 250 and the divisional voltage applied to liquid crystal layer 250, such that the threshold voltages for alignment state transitions of cholesteric liquid crystal in the area where intervening layer 280 exists are shifted with respect to the threshold voltages for alignment state transitions of the cholesteric liquid crystal in the area where intervening layer 280 does not exist, whereby areas having different threshold voltages are included in a plane of liquid crystal layer 250. In other words, with a single unevenness pattern provided by intervening layer 280, three gradation levels (bright, dark, and intermediate) are achieved only by controlling the applied voltage.

On the other hand, it has been disclosed to provide a plurality of unevenness patterns at different densities on an electrode surface of a ferroelectric liquid crystal display device to control the switching threshold values and achieve an area gradation (see U.S. Pat. No. 5,495,352, for example), but this technique is based on the phenomenon that the switching voltage of the ferroelectric liquid crystal changes depending on the density of unevennesses on the electrode surface. Thus, in this technique, to achieve four gradation levels, for example, it is necessary to form three unevenness patterns at different densities on the electrode surface. Therefore, unlike Exemplary Embodiment of the present invention, the prior art technique can only achieve two gradation levels (bright and dark) with a single unevenness pattern, and thus is a different technology from Exemplary Embodiment of the present invention.

FIG. 5 shows characteristics of resistance of photosensitive layer 230 relating to Exemplary Embodiment of the present invention. In this drawing, the vertical axis represents the resistance of photosensitive layer 230 while the horizontal axis represents a quantity of light irradiated on photosensitive layer 230. Photosensitive layer 230 has a certain resistance when no light is irradiated thereon. When light is irradiated on photosensitive layer 230 and a quantity of light becomes greater than first quantity of light L1, the resistance of photosensitive layer 230 decreases with an increase in the quantity of light irradiated on photosensitive layer 230. Then, when the quantity of light exceeds second quantity of light L2, a rate of decrease in the resistance of photosensitive layer 230 with respect to an increase in the quantity of light, resulting in a substantially stable resistance. In this example, the quantity of light irradiated from light-irradiating section 130 is a quantity of light P1 that is greater than second quantity of light L2.

The voltage applied between transparent electrodes 220, 260 from voltage-applying section 140 is partially applied to photosensitive layer 230 also. In this example, voltage-applying section 140 is adapted to provide a voltage such that the voltage applied to liquid crystal layer 250 while light is irradiated on photosensitive layer 230 becomes voltage V1, V2, or V3 (hereinafter, the voltages generated from voltage-applying section 140 corresponding to voltages V1, V2, and V3 applied to liquid crystal layer 250 are denoted by VT1, VT2, and VT3, respectively), and each layer is designed such that when no light is irradiated on photosensitive layer 230, the voltage applied to liquid crystal layer 250 is below voltage VB1. Thus, the structure of electronic paper 200 has been explained in the above description.

Next, explanation will be made of an operation when recording apparatus 100 records an image on electronic paper 200. When electronic paper 200 is set in recording apparatus 100 and recording of an image is instructed via operating section 120, control section 110 acquires image information and starts a process for recording the image on electronic paper 200. This image information represents the image to be recorded with “bright,” “intermediate,” or “dark” assigned to each pixel.

Then, control section 110 controls voltage-applying section 140 to apply a voltage having voltage value VT1 between transparent electrodes 220, 260 (in this example, the voltage has a frequency of 50 Hz and is applied for 200 ms), while controlling light-irradiating section 130 to irradiate light on a surface of photosensitive layer 230 corresponding to the whole pixels. Subsequently, when the voltage application and light irradiation are stopped, all of the pixels of electronic paper 200 exhibit the bright color. In this state, liquid crystal layer 250 is in the planar alignment state in both of areas 251 and 252, as described above.

Next, control section 110 controls voltage-applying section 140 to apply a voltage having voltage value VT2 between transparent electrodes 220, 260 (in this example, the voltage has a frequency of 50 Hz and is applied for 300 ms), while controlling light-irradiating section 130 to irradiate light on photosensitive layer 230 in regions of pixels designated with “intermediate” according to the image information. Then, when the voltage application and light irradiation are stopped, the pixels of electronic paper 200 designated with “intermediate” according to the image information exhibit the intermediate color. In this state, liquid crystal layer 250 in the regions of pixels irradiated with light is in the focal-conic alignment state in area 251, and in the planar alignment state in area 252, as described above. In the other pixels, liquid crystal layer 250 is in the planar alignment state in both of areas 251 and 252.

Subsequently, control section 110 controls voltage-applying section 140 to apply a voltage having voltage value VT3 between transparent electrodes 220, 260 (in this example, the voltage has a frequency of 50 Hz and is applied for 300 ms), while controlling light-irradiating section 130 to irradiate light on photosensitive layer 230 in regions of pixels designated with “dark” according to the image information. Then, when the voltage application and light irradiation are stopped, the pixels of electronic paper 200 designated with “dark” according to the image information exhibit the dark color. In this state, liquid crystal layer 250 in the regions of pixels irradiated with light is in the focal-conic alignment state in both of areas 251 and 252, as described above. In the other pixels, liquid crystal layer 250 maintains the above-described alignment states.

It should be noted that the above-described method of voltage application is a mere example, and a variety of other methods may be adopted. For example, when a voltage having voltage value VT1 is applied, light may be irradiated on photosensitive layer 230 in regions of pixels designated with “bright.” In such a case, recordation of image information on the pixels designated with “intermediate” and “dark” may be carried out in advance. Further, when light is irradiated on photosensitive layer 230 in regions of pixels designated with “intermediate” and “dark,” a voltage having voltage value VT1 may be applied before applying voltages having voltage values VT2, VT3.

As described above, electronic paper 200 according to Exemplary Embodiment of the present invention has an area in which intervening layer 280 having a dielectric constant lower than that of liquid crystal layer 250 is provided between liquid crystal layer 250 and transparent electrode 260 and an area in which intervening layer 280 is not provided, whereby the electric field generated in liquid crystal layer 250 has a different strength in the area (area 251) corresponding to intervening layer 280 than in the other area (area 252). As a result, when a prescribed voltage is applied between transparent electrodes 220, 260, the alignment state of liquid crystal layer 250 can vary depending on the areas, whereby control of an intermediate gradation level is facilitated.

Thus, Exemplary Embodiment of the present invention is explained above, but the present invention can be carried out in a variety of other embodiments, as described below.

### Modified Embodiment 1

In the above-described Exemplary Embodiment, intervening layer 280 is a member having a dielectric constant lower than the dielectric constant of liquid crystal layer 250, but intervening layer 280 may be a member having a higher dielectric constant than liquid crystal layer 250. Intervening layer 280 having a dielectric constant that is different from the dielectric constant of liquid crystal layer 250 can result in different strengths of electric field generated in area 251 and in area 252.

Also, intervening layer 280 may be made of an electrically conductive material. As the electrically conductive material, a transparent electroconductive polymer such as PEDOT:PSS (poly(3,4-ethylenedioxythiophene)poly(styrenesulfonate)), or a light-transmissive metal or semiconductor may be utilized, for example. In this case, liquid crystal layer 250 has a smaller thickness in area 251 than in area 252, and thus the strength of an electric field generated in liquid crystal layer 250 in area 251 becomes higher than in the other area.

### Modified Embodiment 2

In the above-described Exemplary Embodiment, the material constituting intervening layer 280 may be modified to vary for different areas. For example, intervening layer 280 may be made of both an electrically conductive material (as described with respect to Modified Embodiment 1) and a dielectric material (as described with respect to Exemplary Embodiment). The part of intervening layer 280 made of an electrically conductive material will be referred to as intervening layer 280A in the following description.

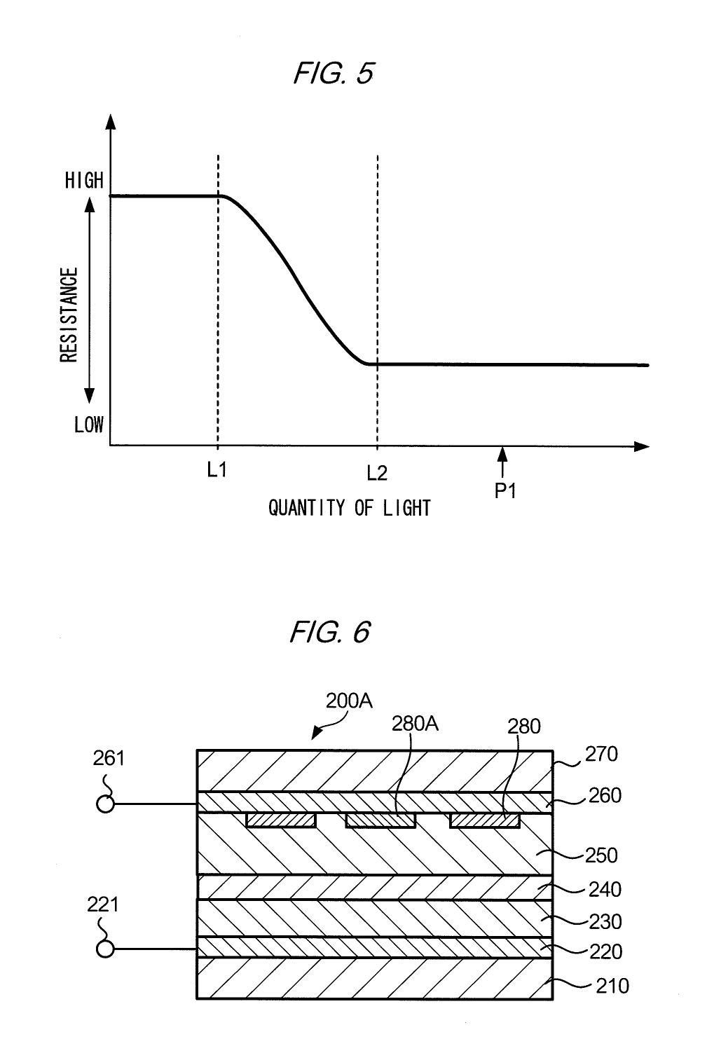

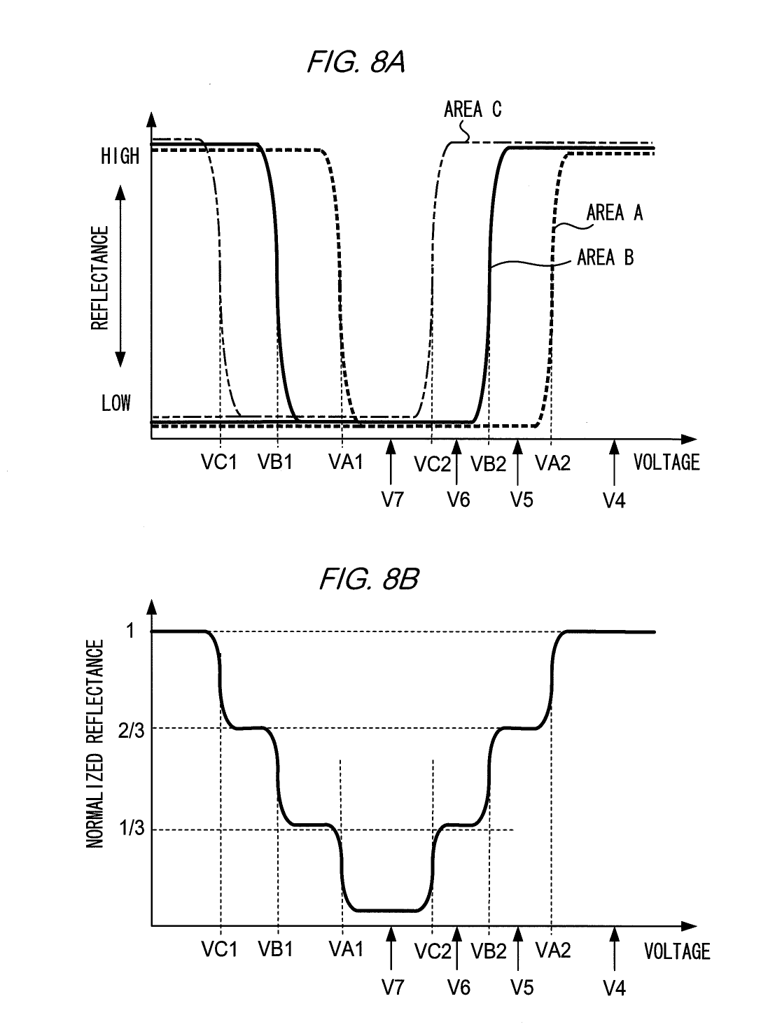

FIG. 6 is a cross-sectional view showing a structure of electronic paper 200A relating to Modified Embodiment 2. FIG. 7 shows an arrangement of intervening layers 280, 280A of electronic paper 200A relating to Modified Embodiment 2 when viewed from the display surface. FIGS. 8A and 8B show characteristics of reflectance of liquid crystal layer 250 relating to Modified Embodiment 2.

Compared with electronic paper 200 of Exemplary Embodiment, in electronic paper 200A, half of intervening layer 280 is replaced with electroconductive intervening layer 280A. Consequently, as shown in FIG. 7, half of area 251 in Exemplary Embodiment is replaced with area 253 (or area C) that corresponds to intervening layer 280A. It should be noted that the occupation ratio between areas 251, 252, and 253 is determined according to the same criteria as in Exemplary Embodiment, and thus, if the transmittance of each intervening layer 280, 280A is 100%, the occupation ratio is determined as 1:1:1. If the transmittance is different between intervening layers 280 and 280A, the occupation ratio may be altered accordingly in the same way as in Exemplary Embodiment.

As described above, the strength of an electric field generated in liquid crystal layer 250 is different among areas 251, 252 and 253, and this results in the characteristics of reflectance of liquid crystal layer 250 in respective areas as shown in FIGS. 8A and 8B. As will be understood, the reflectance of each area can be controlled by controlling the voltage applied to liquid crystal layer 250 during irradiation of light such that the voltage is equal to voltage V7 (VA1≦V7<VC2), V6 (VC2≦V6<VB2), V5 (VB2≦V5<VA2), or V4 (VA2≦V4).

Specifically, in a case where the applied voltage is controlled to voltage V4, areas 251, 252, and 253 are controlled to exhibit “bright, bright, bright” or the normalized reflectance is equal to 1 (one), in a case where the applied voltage is controlled to voltage V5, areas 251, 252, and 253 are controlled to exhibit “dark, bright, bright” so that the normalized reflectance is equal to ⅔, in a case where the applied voltage is controlled to voltage V6, areas 251, 252, and 253 are controlled to exhibit “dark, dark, bright” so that the normalized reflectance is equal to ⅓, and in a case where the applied voltage is controlled to voltage V7, areas 251, 252, and 253 are controlled to exhibit “dark, dark, dark.” In this way, the number of gradation levels expressed can be increased.

### Modified Embodiment 3

In the above-described Exemplary Embodiment, the thickness of intervening layer 280 does not vary in different areas, but the thickness may vary for each area. For example, an electronic paper may comprise intervening layer 280B in area 253 of Modified Embodiment 2 such that intervening layer 280B has a greater thickness than intervening layer 280 in area 251.

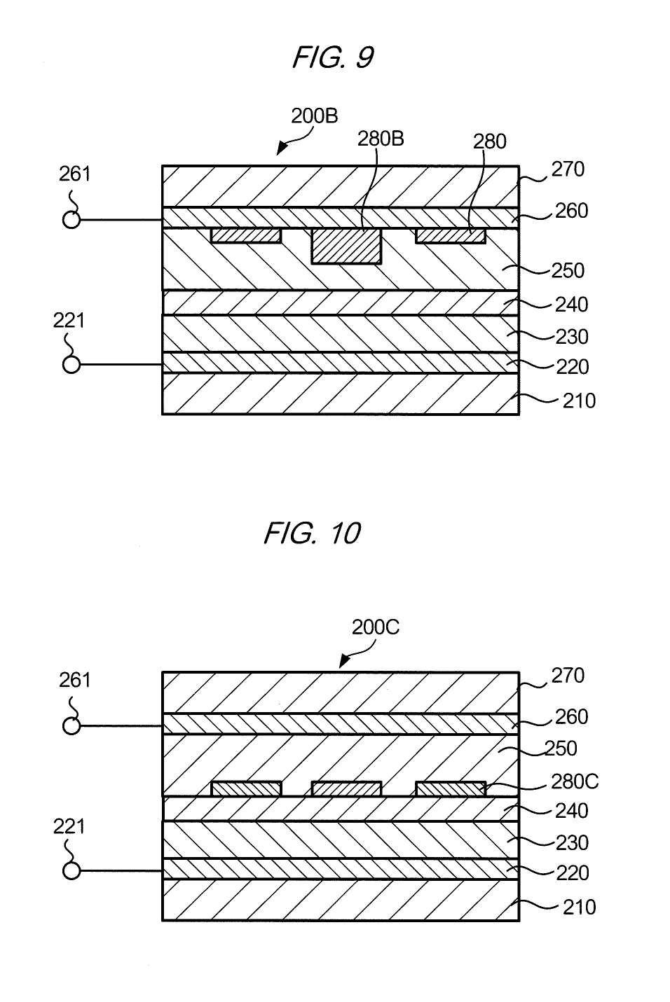

FIG. 9 is a cross-sectional view showing the structure of electronic paper 200B according to Modified Embodiment 3. In a case where intervening layer 280B having a larger thickness is made of a material having the same dielectric constant as that of intervening layer 280, the strength of an electric field generated in liquid crystal layer 250 is weakened even further in area 253 than in area 251. Thus, in this way, the number of gradation levels expressed is increased as in Modified Embodiment 2. Also, it is to be noted that Modified Embodiment 3 may be applied to Modified Embodiment 2 so that intervening layers having different thicknesses are made of different materials.

### Modified Embodiment 4

In the above-described Exemplary Embodiment, intervening layer 280 is provided so as to be sandwiched between liquid crystal layer 250 and transparent electrode 260, but it may be provided so as to be sandwiched between liquid crystal layer 250 and colored layer 240.

FIG. 10 is a cross-sectional view showing the structure of electronic paper 200C according to Modified Embodiment 4. For intervening layer 280C provided between liquid crystal layer 250 and colored layer 240 as shown in FIG. 10, a material having a low transmittance may be used. In determining the occupation ratio between respective areas, the condition used when the transmittance of intervening layer 280 is 100% in Exemplary Embodiment can be applied. Intervening layer 280C may be provided between any layers so long as the strength of an electric field generated in liquid crystal layer 250 is different between area 251 in which intervening layer 280C is provided and area 252 in which intervening area 280C is not provided. In other words, the intervening layer may be provided anywhere between liquid crystal layer 250 and transparent electrode 220 or transparent electrode 260. It should be also noted that it is possible to use both of intervening layer 280 of Exemplary Embodiment and intervening layer 280C of Modified Embodiment 4, thereby to provide multiple intervening layers at different positions in the direction of stacking of the layers.

### Modified Embodiment 5

In the above-described Exemplary Embodiment, the occupation ratio between areas 251 and 252 is determined such that the normalized reflectance is equal to ½ in a state that areas 251, 252 appear “dark, bright,” but the occupation ratio may be determined such that the normalized reflectance in the same state is equal to ⅔.

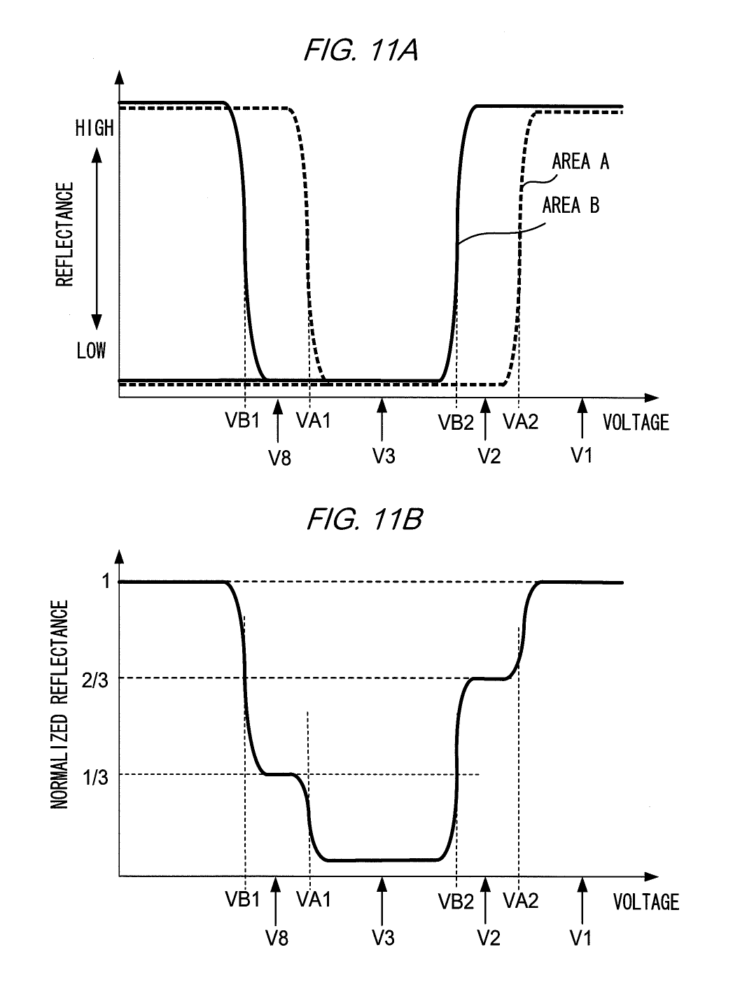

FIGS. 11A and 11B show characteristics of reflectance of liquid crystal display 250 according to Modified Embodiment 5. In the case where the occupation ratio is determined such that the normalized reflectance is equal to ⅔ in the state that areas 251, 252 appear “dark, bright,” the normalized reflectance in a state that areas 251, 252 appear “bright, dark” is equal to ⅓, as shown in FIG. 11B (it is assumed here that the transmittance of intervening layer 280 is 100%). In this case, by controlling the recording voltage as described below, the number of gradation levels expressed is increased.

The image information in this case represents an image to be recorded by designating each pixel with “bright,” “intermediate bright (a color closer to “bright” than “intermediate” in Exemplary Embodiment),” “intermediate dark (a color closer to “dark” than “intermediate” in Exemplary Embodiment),” or “dark.”

The recordation of image regarding “bright,” “intermediate bright,” and “dark” is the same as that in Exemplary Embodiment except that “intermediate” in Exemplary Embodiment is replaced with “intermediate bright,” and therefore, explanation thereof is omitted. After the process described in Exemplary Embodiment, control section 110 controls voltage-applying section 140 so that a voltage having voltage value VT8 (which, in this example, has a frequency of 50 Hz and is applied for 300 ms) is applied between transparent electrodes 220, 260 thereby to cause voltage V8 (VB1≦V8<VA1) to be applied to liquid crystal layer 250, and at the same time controls light-irradiating section 130 to irradiate light on photosensitive layer 230 in regions of pixels designated with “intermediate dark” according to the image information. Then, when the voltage application and light irradiation are stopped, the pixels of electronic paper 200 designated with “intermediate dark” according to the image information exhibit a dark gray in accordance with the normalized reflectance of ⅓. In this state, liquid crystal layer 250 in the regions of pixels irradiated with light is in the focal-conic alignment state in area 252, and remains in the planar alignment state, which was previously set when all of the pixels were controlled to appear “bright,” in area 251,

### Modified Embodiment 6

In the above-described Exemplary Embodiment, an image is recorded on electronic paper by irradiation of light on photosensitive layer according to the image information, but the image recordation can be achieved without using light irradiation. In such a case, it is not necessary to use photosensitive layer 230, but transparent electrodes 220, 260 are configured such that the voltage applied to liquid crystal layer 250 can be set for each pixel (for example, electrodes 220, 260 are divided so that each divided electrode corresponds to a pixel), and voltage-applying section 140 is configured to be able to vary the applied voltage for each pixel. It is also possible to provide electronic paper 200 with a circuit for sequentially selecting a pixel to which a voltage is applied.

In such a modified embodiment, for a pixel that is to appear bright, the voltage applied to liquid crystal layer 250 is set to voltage V1 before stopping of the voltage application. Similarly, for a pixel that is to exhibit an intermediate color, the voltage is set to voltage V2, and for a pixel that is to appear dark, the voltage is set to voltage V3, before stopping of the voltage application.

The foregoing description of the embodiments of the present invention is provided for the purposes of illustration and description. It is not intended to be exhaustive or to limit the invention to the precise forms disclosed. Obviously, many modifications and variations will be apparent to practitioners skilled in the art. The embodiments were chosen and described to best explain the principles of the invention and its practical applications, thereby enabling others skilled in the art to understand the invention for a variety of embodiments and with various modifications as are suited to the particular use contemplated. It is intended that the scope of the invention be defined by the following claims and their equivalents.

What is claimed is:

1. A display medium comprising:
a pair of electrodes to which a voltage is applied;
a cholesteric liquid crystal layer provided between the pair of electrodes, wherein an alignment state of the cholesteric liquid crystal layer changes depending on a strength of an electric field generated upon application of a voltage to the pair of electrodes; and
an intervening layer provided in an area between a part of the cholesteric liquid crystal layer and one of the pair of electrodes such that a strength of an electric field generated in the part of the cholesteric liquid crystal layer upon application of a voltage to the pair of electrodes is different from a strength of an electric field generated in another part of the cholesteric liquid crystal layer.

2. The display medium according to claim 1, wherein the area in which the intervening layer is provided includes a plurality of areas, and a material constituting the intervening layer in one of the plurality of areas is different from a material constituting the intervening layer in at least one other area.

3. The display medium according to claim 1, wherein the area in which the intervening layer is provided includes a plurality of areas, and a thickness of the intervening layer in one of the plurality of areas is different from a thickness of the intervening layer in at least one other area.

4. The display medium according to claim 2, wherein a thickness of the intervening layer in one of the plurality of areas is different from a thickness of the intervening layer in at least one other area.

5. The display medium according to claim 1, wherein a thickness of the part of the cholesteric liquid crystal layer is different from a thickness of the another part of the cholesteric liquid crystal layer.

6. The display medium according to claim 2, wherein a thickness of the part of the cholesteric liquid crystal layer is different from a thickness of the another part of the cholesteric liquid crystal layer.

7. The display medium according to claim 3, wherein a thickness of the part of the cholesteric liquid crystal layer is different from a thickness of the another part of the cholesteric liquid crystal layer.

8. The display medium according to claim 4, wherein a thickness of the part of the cholesteric liquid crystal layer is different from a thickness of the another part of the cholesteric liquid crystal layer.

9. The display medium according to claim 1, further comprising a photosensitive layer disposed between the cholesteric liquid crystal layer and one of the pair of electrodes such that irradiation of light on the photosensitive layer changes the strength of the electric field generated in the cholesteric liquid crystal layer when a voltage is applied to the pair of electrodes.

10. The display medium according to claim 2, further comprising a photosensitive layer disposed between the cholesteric liquid crystal layer and one of the pair of electrodes such that irradiation of light on the photosensitive layer changes the strength of the electric field generated in the cholesteric liquid crystal layer when a voltage is applied to the pair of electrodes.

11. The display medium according to claim 3, further comprising a photosensitive layer disposed between the cholesteric liquid crystal layer and one of the pair of electrodes such that irradiation of light on the photosensitive layer changes the strength of the electric field generated in the cholesteric liquid crystal layer when a voltage is applied to the pair of electrodes.

12. The display medium according to claim 4, further comprising a photosensitive layer disposed between the cholesteric liquid crystal layer and one of the pair of electrodes such that irradiation of light on the photosensitive layer changes the strength of the electric field generated in the cholesteric liquid crystal layer when a voltage is applied to the pair of electrodes.

13. A recording apparatus for recording an image on the display medium according to claim 1, comprising:
a voltage applying section that applies a voltage to the pair of electrodes of the display medium;
an acquisition section that acquires image information representing an image; and
a control section that controls the voltage provided from the voltage applying section to control the alignment state of the part of the cholesteric liquid crystal layer and of the another part of the cholesteric liquid crystal layer according to the image information acquired by the acquisition section.

14. A recording apparatus for recording an image on the display device according to claim 9, comprising:
a voltage applying section that applies a voltage to the pair of electrodes of the display medium;
a light irradiating section that irradiates light onto the display device;
an acquisition section that acquires image information representing an image; and
a control section that controls the voltage provided from the voltage applying section and an irradiation region of light from the light irradiating section to control the alignment state of the part of the cholesteric liquid crystal layer and of the another part of the cholesteric liquid crystal layer according to the image information acquired by the acquisition section.

15. The recording apparatus according to claim 14, wherein the area in which the intervening layer is provided includes a plurality of areas, and a size of each of the plurality of areas is smaller than a size of a minimum areal unit in the control of light irradiation region conducted by the control section.
